(19) United States
(12) Patent Application Publication
(10) Pub. No.: US 2018/0072202 A1
(43) Pub. Date: Mar. 15, 2018

(54) VEHICLE SEAT

(71) Applicant: TOYOTA BOSHOKU KABUSHIKI KAISHA, Aichi (JP)

(72) Inventors: Yoshiyuki KUMAZAKI, Aichi (JP); Masafumi NOMURA, Aichi (JP)

(73) Assignee: TOYOTA BOSHOKU KABUSHIKI KAISHA, Aichi (JP)

(21) Appl. No.: 15/703,151

(22) Filed: Sep. 13, 2017

(30) Foreign Application Priority Data
Sep. 15, 2016 (JP) 2016-180481

(51) Int. Cl. B60N 2/48; B60N 2/68

(52) U.S. Cl. CPC B60N 2/48; B60N 2002/4888; B60N 2/682

(57) ABSTRACT

Multiple types of attachment positions are provided such that at least two of at least three first holes and at least two of at least three second holes align. At least one of the at least two of the at least three first holes that aligns with one of the at least two of the at least three second holes in one of the multiple types of attachment positions does not align with the second holes in a remainder of the multiple types of attachment positions. Alternatively, at least one of the at least two of the at least three second holes that align with one of the at least two of the at least three first holes in one of the multiple types of attachment positions does not align with the at least three first holes in the remainder of the multiple types of attachment positions.

### CROSS-REFERENCE TO RELATED APPLICATIONS

The present application claims the benefit of Japanese Patent Application No. 2016-180481 filed on Sep. 15, 2016 with the Japan Patent Office, the entire disclosure of which is incorporated herein by reference.

### BACKGROUND

The present disclosure is related to a vehicle seat.

A vehicle seat disclosed in, for example, Japanese Unexamined Patent Application Publication No. 2014-19316 comprises a frame that supports the back of an occupant, a bracket attached to the upper portion of the frame, and a headrest-support bracket attached to the bracket from a side opposite to where the frame is attached. A headrest is attached to the headrest-support bracket.

In a known technique, the attachment position of the bracket relative to the frame is determined as follows. The frame is provided with holes (hereinafter referred to as frame holes). The bracket is also provided with holes (hereinafter referred to as second hole). The attachment position of the bracket relative to the frame is determined such that the frame holes align with the second hole when seen in a front view. Then, the frame and the bracket are welded.

### SUMMARY

Even in one set of a frame and a bracket, the attachment position of the bracket relative to the frame may vary depending on, for example, the specification or the model of a car. To determine the attachment position of the bracket relative to the frame in the above-described technique, the positions of the frame holes or the positions of the second holes need to be changed for each specification or model of a car. This makes the manufacturing process of a vehicle seat complicated.

It is desirable that one aspect of the present disclosure provides a vehicle seat made in a simple manufacturing process even in a case where multiple types of attachment positions of a bracket relative to a frame are provided.

One aspect of the present disclosure provides a vehicle seat comprising a frame, a main bracket, and a headrest-support bracket. The frame supports a back of an occupant. The main bracket is attached to an upper portion of the frame. The headrest-support bracket is attached to the main bracket from a side opposite to where the frame is attached. The frame comprises at least three first holes. The main bracket comprises at least three second holes. The at least three first holes and the at least three second holes are provided such that a requirement (a) and a requirement (b) are met, or the requirement (a) and a requirement (c) are met.

The requirement (a), the requirement (b), and the requirement (c) are as follows. (a) Multiple types of attachment positions of the main bracket relative to the frame are provided such that at least two of the at least three first holes and at least two of the at least three second holes align.

(b) At least one of the at least two of the at least three first holes that aligns with one of the at least two of the at least three second holes in one of the multiple types of attachment positions does not align with any of the at least three second holes in the remainder of the multiple types of attachment positions.

(c) At least one of the at least two of the at least three second holes that aligns with one of the at least two of the at least three first holes in one of the multiple types of attachment positions does not align with any of the at least three first holes in the remainder of the multiple types of attachment positions.

In the vehicle seat according to one aspect of the present disclosure, since the requirement (a) is met by the at least three first holes and the at least three second holes, multiple types of attachment positions are provided such that at least two of the at least three first holes and at least two of the at least three second holes align. Accordingly, in one set of the frame and the main bracket, a specific type of attachment position can be selected from the multiple types of attachment positions. As a result, the manufacturing process of the vehicle seat can be simplified.

Moreover, in the vehicle seat according to one aspect of the present disclosure, one of the requirement (b) or the requirement (c) is met by the at least three first holes and the at least three second holes. In a case where the requirement (b) is met by the at least three first holes and the at least three second holes, there is only one attachment position wherein both the specific at least two first holes and the at least two second holes align. Thus, if a specific type of attachment position is selected such that all the specific at least two first holes and the at least two second holes align, selecting an inappropriate attachment position in the frame and the main bracket can be inhibited.

On the other hand, in a case where the requirement (c) is met by the at least three first holes and the at least three second holes, there is only one attachment position wherein all the specific at least two second holes and the at least two first holes align. Thus, if a specific type of attachment position is selected such that all the specific at least two second holes and the at least two first holes align, selecting an inappropriate attachment position in the frame and the main bracket can be inhibited.

In one aspect of the present disclosure, one of the at least three first holes or the at least three second holes may be located substantially at four vertices of a virtual rectangle and substantially at a midpoint of a specified side of the virtual rectangle on one of the frame or the main bracket. Moreover, an other of the at least three first holes or the at least three second holes may be located, in one of the multiple types of attachment positions, at both ends of the specified side and at a midpoint of one side facing the specified side of the virtual rectangle on an other of the frame or the main bracket.

According to a vehicle seat configured as described above, the first holes and the second holes that meet the requirement (a) and the requirement (b), or that meet the requirement (a) and the requirement (c) can be achieved with a simple structure.

In one aspect of the present disclosure, diameters of the at least three first holes are larger than diameters of the at least three second holes.

According to the vehicle seat configured as described above, a jig is inserted from one of the first holes into one of the second holes. This enables even easier alignment of the frame hole and the bracket hole in a front view.

### BRIEF DESCRIPTION OF THE DRAWINGS

An example embodiment of the present disclosure will be described hereinafter by way of example with reference to the accompanying drawings, in which:

FIG. 1 is a perspective view showing the structure of a vehicle seat according to an embodiment the present disclosure;

FIG. 2 is an exploded perspective view showing the structures of a frame and of a main bracket;

FIG. 3 is a front view showing a first attachment position;

FIG. 4 is a front view showing a second attachment position; and

FIG. 5 is a front view showing a third attachment position.

### DETAILED DESCRIPTION OF THE PREFERRED EMBODIMENTS

### First Embodiment

1. Structure of Vehicle Seat 1

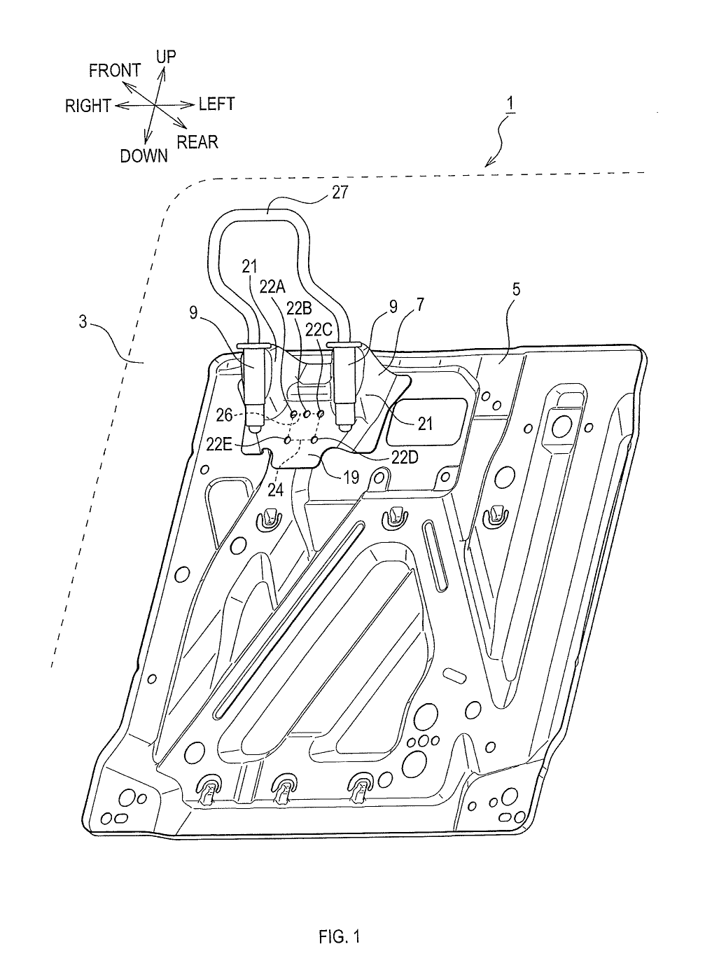

The structure of a vehicle seat 1 will be described based on FIGS. 1 to 5. The vehicle seat 1 shown in FIG. 1 is a seat installed in an automobile. The vehicle seat 1 comprises a seatback 3 and a seat cushion (not shown).

The vehicle seat 1 comprises a frame 5, a main bracket 7, and two headrest-support brackets 9 (a first and a second headrest-support brackets 9). The frame 5 is a plate-like member having substantially a rectangle shape. The frame 5 forms a part of a framework of the seatback 3. The frame 5 supports the back of an occupant.

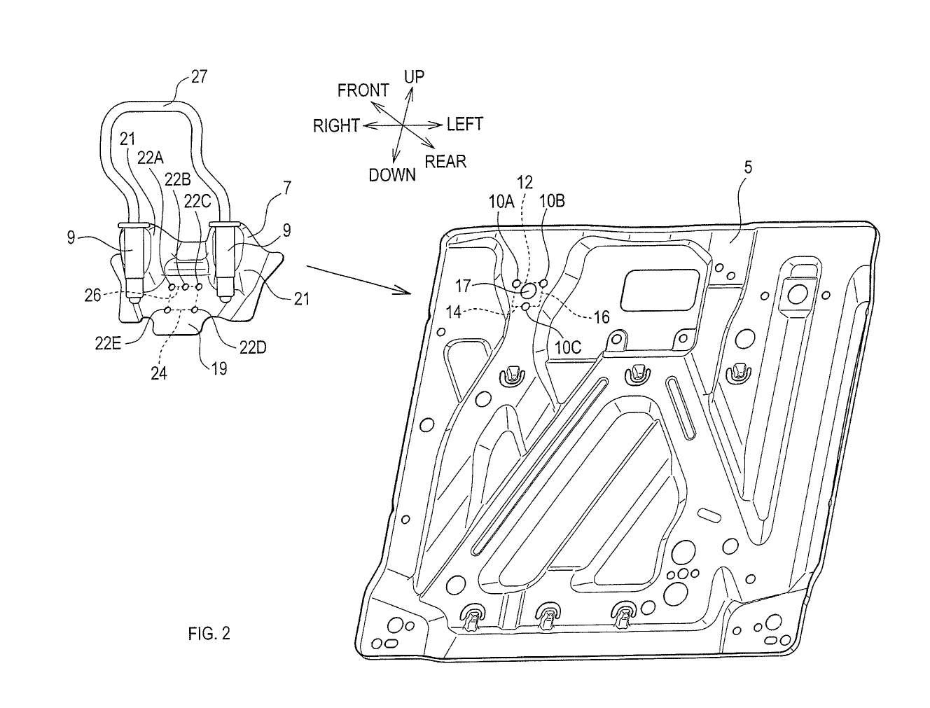

As shown in FIG. 2, in the upper right portion of the frame 5, three frame holes (corresponding to one example of the first holes) 10A, 10B, 10C are provided. The left-right direction and the up-down direction in the drawing correspond to the left-right direction and the up-down direction of the vehicle seat 1 and the automobile. The frame holes 10A, 10B, 10C penetrate the frame 5 in the front-rear direction. The front-rear direction in the drawing corresponds to the front-rear direction of the vehicle seat 1 and the automobile. The shapes of the frame holes 10A, 10B, 10C are circular when seen in a front view. The diameters of the frame holes 10A, 10B, 10C are all identical.

The positions (height) of the frame holes 10A, 10B in the up-down direction of the frame 5 are aligned. The frame hole 10C is provided below the frame holes 10A, 10B. As shown in FIG. 2, the line segment connecting the center of the frame hole 10A and the center of the frame hole 10B is referred to as a side 12 of a virtual rectangle 16. The virtual rectangle 16 comprises a side 14 facing the side 12 and passing through the center of the frame hole 10C. The center of frame hole 10C is located at the midpoint of the side 14. A hole 17 is formed on the frame 5 in an area surrounded by the frame holes 10A, 10B, 10C.

As shown in FIG. 1, the main bracket 7 is a member attached in the upper portion of the frame 5 from the front side. The main bracket 7 comprises a base portion 19 and two projecting portions 21. The base portion 19 has a planar-plate-like shape and faces the frame 5. The projecting portions 21 are disposed in the upper portion of the main bracket 7 in both the right side and the left side. The projecting portions 21 project further forward than the base portion 19.

The base portion 19 is provided with five bracket holes (corresponding to the second holes) 22A, 22B, 22C, 22D, 22E. The bracket holes 22A, 22B, 22C, 22D, 22E penetrate the base portion 19 in the front-rear direction. The shapes of the bracket holes 22A, 22B, 22C, 22D, 22E are circular in a front view. The diameters of the bracket holes 22A, 22B, 22C, 22D, 22E are all identical. The diameters of the bracket holes 22A, 22B, 22C, 22D, 22E are smaller than the diameters of the frame holes 10A, 10B, 10C.

The positions (height) of the bracket holes 22A, 22B, 22C in the up-down direction of the base portion 19 are aligned. The bracket holes 22D, 22E are provided lower than the bracket holes 22A, 22B, 22C. The positions (height) of the bracket holes 22D, 22E in the up-down direction of the base portion 19 are aligned. The bracket hole 22D is provided immediately below the bracket hole 22C in a front view. The bracket hole 22E is disposed immediately below the bracket hole 22A in a front view.

The centers of the bracket holes 22A, 22C, 22D, 22E are respectively located substantially at four vertices of a virtual rectangle 24 on the surface of the base portion 19. The center of the bracket hole 22B is located substantially at the midpoint of the side 26 connecting the centers of two bracket holes 22A, 22C in the virtual rectangle 24. The shape and the size of the virtual rectangle 24 are identical to the shape and the size of the virtual rectangle 16.

The headrest-support brackets 9 respectively have hollow cylindrical shapes and are attached to the projecting portions 21 from the front side. That is, the headrest-support brackets 9 are attached to the main bracket 7 from a side opposite to where the frame 5 is attached. The headrest-support brackets 9 are directed such that the axial direction of the headrest-support brackets 9 is in the up-down direction in a front view. The upper ends and the lower ends of the headrest-support brackets 9 are open. Into the upper end of the first headrest-support bracket 9, a first end of a stay 27 having a U-like shape is inserted. Into the upper end of the second headrest-support bracket 9, a second end of the stay 27 is inserted. The stay 27 is a part of a headrest (not shown). By the stay 27 being inserted into the headrest-support brackets 9 in the aforementioned manner, the headrest is secured to the seatback 3.

The main bracket 7 is attached to the frame 5 by spot welding. The attachment position of the main bracket 7 relative to the frame 5 (hereinafter referred to as a P-B attachment position) is determined with the frame holes 10A, 10B, 10C and the bracket holes 22A, 22B, 22C, 22D, 22E.

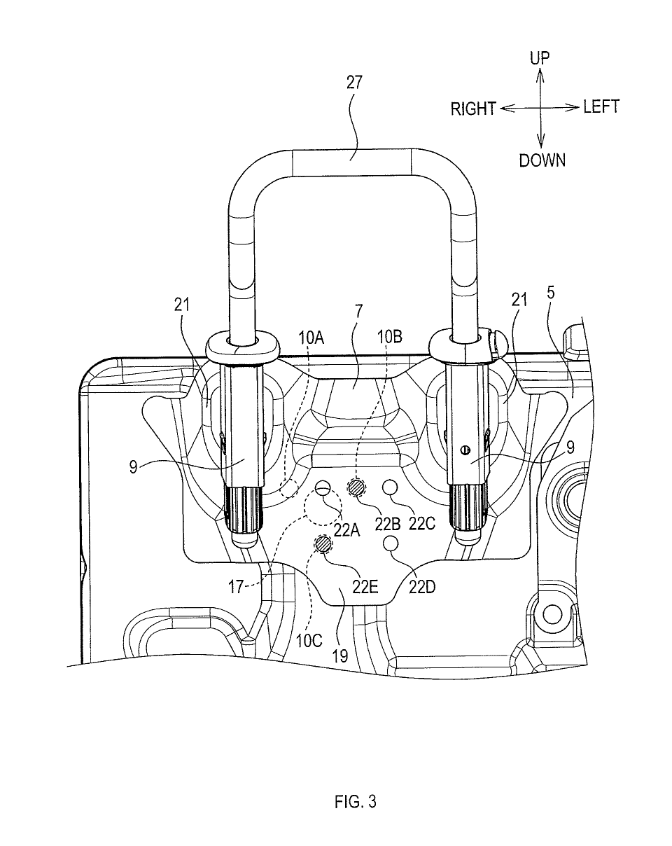

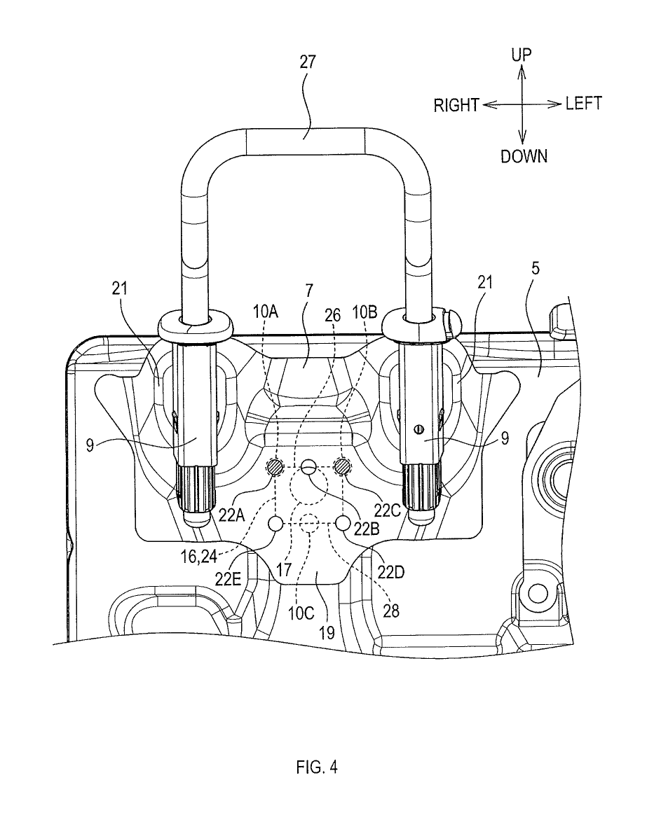

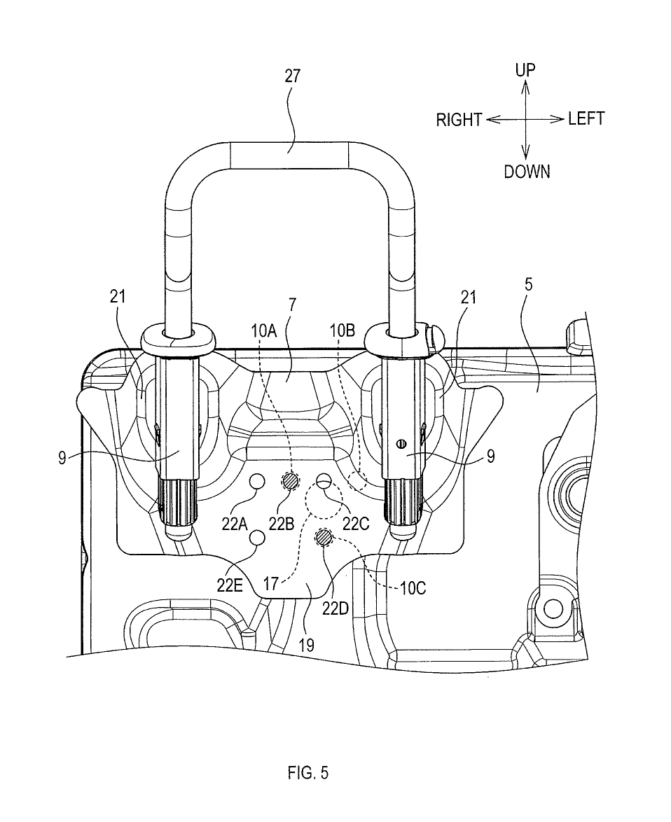

There are multiple types of P-B attachment positions; for example, a first attachment position shown in FIG. 3, a second attachment position shown in FIG. 4, and a third attachment position shown in FIG. 5.

As shown in FIG. 3, in the first attachment position, the frame hole 10B and the bracket hole 22B align in the front view. Moreover, in the first attachment position, the frame hole 10C and the bracket hole 22E align in the front view. In the present embodiment, the alignment of, for example, the frame hole 10B and the bracket hole 22B means that the bracket hole 22B having a diameter smaller than the diameter of the frame hole 10B is fitted in the frame hole 10B. The frame hole 10A does not align with any of the bracket holes 22A, 22B, 22C, 22D, 22E in the front view. The bracket holes 22A, 22C, 22D do not align with any of the frame holes 10A, 10B, 10C in a front view.

In a case where the P-B attachment position is in the first attachment position, a linear rod-like jig is inserted in the frame hole 10B and the bracket hole 22B in the front-rear direction. In addition, another linear rod-like jig is inserted in the frame hole 10C and the bracket hole 22E in the front-rear direction. Accordingly, the P-B attachment position is determined.

As shown in FIG. 4, in the second attachment position, the frame hole 10A and the bracket hole 22A align in the front view. Moreover, in the second attachment position, the frame hole 10B and the bracket hole 22C align in the ^{front} view. The frame hole lOG does not align with any of the bracket holes 22A, 22B, 22C, 22D, 22E in the front view. The bracket holes 22B, 22D, 22E do not align with any of the frame holes 10A, 10B, 10C in the front view.

In a case where the P-B attachment position is in the second attachment position, a linear rod-like jig is inserted in the frame hole 10A and the bracket hole 22A in the front-rear direction. In addition, another linear rod-like jig is inserted in the frame hole 10B and the bracket hole 22C in the front-rear direction. Accordingly, the P-B attachment position is determined. In the second attachment position, as compared to in the first attachment position, the main bracket 7 is disposed in the left side relative to the frame 5 in the front view. In the second attachment position, the virtual rectangle 16 and the virtual rectangle 24 align in the front view. In the second attachment position, as compared to in the first attachment position, the height and the direction of the main bracket 7 are not changed; however, the position of the main bracket 7 along the width direction of the seatback 3 is changed.

As shown in FIG. 5, in the third attachment position, the frame hole 10A and the bracket hole 22B align in the front view. Moreover, in the third attachment position, the frame hole IOC and the bracket hole 22D align in the front view. The frame hole 10B does not align with any of the bracket holes 22A, 22B, 22C, 22D, 22E in the front view. The bracket holes 22A, 22C, 22E do not align with any of the frame holes 10A, 10B, 10C in the front view.

In a case where the P-B attachment position is in the third attachment position, a linear rod-like jig is inserted in the frame hole 10A and the bracket hole 22B in the front-rear direction. In addition, another linear rod-like jig is inserted in the frame hole 10C and the bracket hole 22D in the front-rear direction. Accordingly, the P-B attachment position is determined. In the third attachment position, as compared to in the second attachment position, the main bracket 7 is disposed in the left side relative to the frame 5 in the front view. In the third attachment position, as compared to in the first attachment position and the second attachment position, the height and the direction of the main bracket 7 are not changed; however, the position of the main bracket 7 along the width direction of the seatback 3 is changed.

2. Advantages of the Vehicle Seat 1

The vehicle seat 1 provides the following advantages.

(1A) The vehicle seat 1 comprises three types of P-B attachment positions. In one set of the frame 5 and the main bracket 7, a specific type of P-B attachment position can be selected from the three types of P-B attachment positions. This can simplify the manufacturing process of the vehicle seat 1.

(1B) As shown in FIG. 3, in the first attachment position, the frame holes 10B, 10C align with some of the bracket holes 22A, 22B, 22C, 22D, 22E. On the other hand, as shown in FIGS. 4 and 5, at least one of the frame holes 10B, 10C does not align with any of the bracket holes 22A, 22B, 22C, 22D, 22E in the second and the third attachment positions. That is, in the second attachment position, the frame hole 10C does not align with any of the bracket holes 22A, 22B, 22C, 22D, 22E. In the third attachment position, the frame hole 10B does not align with any of the bracket holes 22A, 22B, 22C, 22D, 22E.

Accordingly, in a case where the P-B attachment position is determined such that both the frame holes 10B, 10C align with some of the bracket holes 22A, 22B, 22C, 22D, 22E, the P-B attachment position always falls into the first attachment position. Consequently, when the first attachment position should be selected, selecting the second attachment position or the third attachment position by mistake can be inhibited.

Moreover, as shown in FIG. 4, in the second attachment position, the frame holes 10A, 10B align with some of the bracket holes 22A, 22B, 22C, 22D, 22E. On the other hand, as shown in FIGS. 3 and 5, at least one of the frame holes 10A, 10B does not align with any of the bracket holes 22A, 22B, 22C, 22D, 22E in the first and the third attachment positions. That is, in the first attachment position, the frame hole 10A does not align with any of the bracket holes 22A, 22B, 22C, 22D, 22E. Moreover, in the third attachment position, the frame hole 10B does not align with any of the bracket holes 22A, 22B, 22C, 22D, 22E.

Accordingly, in a case where the P-B attachment position is determined such that both the frame holes 10A, 10B align with some of the bracket holes 22A, 22B, 22C, 22D, 22E, the P-B attachment position always falls in the second attachment position. Consequently, when the second attachment position should be selected, selecting the first attachment position or the third attachment position by mistake can be inhibited.

Moreover, as shown in FIG. 5, in the third attachment position, the frame holes 10A, 10C align with some of the bracket holes 22A, 22B, 22C, 22D, 22E. On the other hand, as shown in FIGS. 3 and 4, at least one of the frame holes 10A, 10C does not align with any of the bracket holes 22A, 22B, 22C, 22D, 22E in the first attachment position and the second attachment position. That is, in the first attachment position, the frame hole 10A does not align with any of the bracket holes 22A, 22B, 22C, 22D, 22E. Moreover, in the second attachment position, the frame hole 10C does not align with any of the bracket holes 22A, 22B, 22C, 22D, 22E.

Accordingly, in a case where the P-B attachment position is determined such that both the frame holes 10A, 10C align with some of the bracket holes 22A, 22B, 22C, 22D, 22E, the P-B attachment position always falls in the third attachment position. Consequently, when the third attachment position should be selected, selecting the first attachment position or the second attachment position by mistake can be inhibited.

(1C) As shown in FIG. 3, in the first attachment position, the bracket holes 22B, 22E align with some of the frame holes 10A, 10B, 10C. On the other hand, as shown in FIGS. 4 and 5, at least one of the bracket holes 22B, 22E does not align with any of the frame holes 10A, 10B, 10C in the second and the third attachment positions. That is, in the second attachment position, the bracket holes 22B, 22E do not align with any of the frame holes 10A, 10B, 10C. Moreover, in the third attachment position, the bracket hole 22E does not align with any of the frame holes 10A, 10B, 10C.

Accordingly, in a case where the P-B attachment position is determined such that both the bracket holes 22B, 22E align with some of the frame holes 10A, 10B, 10C, the P-B attachment position always falls in the first attachment position. Consequently, when the first attachment position should be selected, selecting the second attachment position or the third attachment position by mistake can be inhibited.

Moreover, as shown in FIG. 4, in the second attachment position, the bracket holes 22A, 22C align with some of the frame holes 10A, 10B, 10C. On the other hand, as shown in FIGS. 3 and 5, at least one of the bracket holes 22A, 22C does not align with any of the frame holes 10A, 10B, 10C in the first attachment position and the third attachment position. That is, in the first attachment position, the bracket holes 22A, 22C do not align with any of the frame holes 10A, 10B, 10C. Moreover, in the third attachment position, the bracket holes 22A, 22C do not align with any of the frame holes 10A, 10B, 10C.

Accordingly, in a case where the P-B attachment position is determined such that both the bracket holes 22A, 22C align with some of the frame holes 10A, 10B, 10C, the P-B attachment position always falls in the second attachment position. Consequently, when the second attachment position should be selected, selecting the first attachment position or the third attachment position by mistake can be inhibited.

Moreover, as shown in FIG. 5, in the third attachment position, the bracket holes 22B, 22D align with some of the frame holes 10A, 10B, 10C. On the other hand, as shown in FIGS. 3 and 4, at least one of the bracket holes 22B, 22D does not align with any of the frame holes 10A, 10B, 10C in the first attachment position and the second attachment position. That is, in the first attachment position, the bracket hole 22D does not align with any of the frame holes 10A, 10B, 10C. Moreover, in the second attachment position, the bracket holes 22B, 22D do not align with any of the frame holes 10A, 10B, 10C.

Accordingly, in a case where the P-B attachment position is determined such that both the bracket holes 22B, 22D align with some of the frame holes 10A, 10B, 10C, the P-B attachment position always falls in the third attachment position. Consequently, when the third attachment position should be selected, selecting the first attachment position or the second attachment position by mistake can be inhibited.

(1D) As shown in FIGS. 1 and 2, the center positions of the bracket holes 22A, 22B, 22C, 22D, 22E are located substantially at the four vertices of the virtual rectangle 24 and substantially at the midpoint of the side 26 of the virtual rectangle 24. As shown in FIG. 4, the center positions of the frame holes 10A, 10B are located, in the second attachment position, at the both ends of the side 26. Moreover, the center position of the frame hole 10C is located at the midpoint of the side 28 that faces the side 26 in the virtual rectangle 24.

Due to the arrangement of the frame holes 10A, 10B, 10C and the bracket holes 22A, 22B, 22C, 22D, 22E as described above, the aforementioned advantages (1B) and (1C) can be provided with a simple structure.

(1E) The diameters of the frame holes 10A, 10B, 10C are larger than the diameters of the bracket holes 22A, 22B, 22C, 22D, 22E. Accordingly, jigs can be inserted from one of the frame holes 10A, 10B, 10C into one of the bracket holes 22A, 22B, 22C, 22D, 22E, which enables even easier alignment of some of the frame holes 10A, 10B, 10C and some of the bracket holes 22A, 22B, 22C, 22D, 22E in a front view.

### Other Embodiments

The embodiments of the present disclosure have been described above. However, the present disclosure is not limited to the above-described embodiments and can be variously modified and carried out.

(1) Holes that are made in a similar manner as the bracket holes 22A, 22B, 22C, 22D, 22E may be provided on the frame 5. Holes that are made in a similar manner as the frame holes 10A, 10B, 10C may be provided on the main bracket 7. The aforementioned advantages (1A) to (1D) can be also provided in this structure.

(2) The arrangement patterns of the frame holes 10A, 10B, 10C and of the bracket holes 22A, 22B, 22C, 22D, 22E may be vertically inverted from the arrangement patterns in the first embodiment. The aforementioned advantages (1A) to (1D) can be also provided in this structure.

(3) The arrangement patterns of the frame holes 10A, 10B, 10C and of the bracket holes 22A, 22B, 22C, 22D, 22E may be suitably changed within the range where the aforementioned advantages (1A) to (1D) can be provided.

(4) The P-B attachment position is not limited to three in number.

There may be, for example, two, four, five or more types of P-B attachment positions.

(5) In the P-B attachment positions, the number of the frame holes that align with the bracket holes may be three or more in number.

(6) In the aforementioned embodiments, it is defined that the bracket holes being surrounded by the frame holes corresponds to the alignment of the frame holes and the bracket holes. However, the positions of the frame holes and of the bracket holes may be more strictly defined. For example, it may be defined that the alignment of the center positions of the frame holes and the center positions of the bracket holes corresponds to the alignment of the frame holes and the bracket holes.

(7) Some of the first, the second, and the third attachment positions may be an attachment position/attachment positions where the height or the direction of the main bracket 7 is/are different from the height or the direction of the main bracket 7 in other attachment position(s).

(8) In the aforementioned embodiments, the vehicle seat 1 is installed in an automobile; however, the vehicle seat 1 may be used for other vehicles (for example, a railroad vehicle, an airplane, and a ship).

(9) The function of one component in each of the aforementioned embodiments may be achieved by two or more components; or the function of two or more components may be achieved by one component. Moreover, some part of the structure in each of the aforementioned embodiments may be omitted. At least some part of the structure in each of the aforementioned embodiments may be, for example, added to or replaced with other part(s) of the structures in the other aforementioned embodiments. It should be noted that embodiments of the present disclosure include various modes encompassed in the technical ideas defined by the languages recited in the claims.

What is claimed is:

1. A vehicle seat comprising:
a frame that supports a back of an occupant;
a main bracket attached to an upper portion of the frame; and
a headrest-support bracket attached to the main bracket from a side opposite to where the frame is attached,
wherein the frame comprises at least three first holes,
wherein the bracket comprises at least three second holes, and
wherein the at least three first holes and the at least three second holes are provided such that a requirement (a) and a requirement (b) are met, or the requirement (a) and a requirement (c) are met, the requirement (a), the requirement (b), and the requirement (c) being:
(a) multiple types of attachment positions of the main bracket relative to the frame being provided such that at least two of the at least three first holes and at least two of the at least three second holes align;
(b) at least one of the at least two of the at least three first holes that aligns with one of the at least two of the at least three second holes in one of the multiple types of attachment positions not aligning with any of the at least three second holes in the remainder of the multiple types of attachment positions; and
(c) at least one of the at least two of the at least three second holes that aligns with one of the at least two of the at least three first holes in one of the multiple types of attachment positions not aligning with any of the at least three first holes in the remainder of the multiple types of attachment positions.

2. The vehicle seat according to claim 1,
wherein one of the at least three first holes or the at least three second holes are located substantially at four vertices of a virtual rectangle and substantially at a midpoint of a specified side of the virtual rectangle on one of the frame or the main bracket, and
wherein an other of the at least three first holes or the at least three second holes are located, in one of the multiple types of attachment positions, at both ends of the specified side and at a midpoint of one side facing the specified side of the virtual rectangle on an other of the frame or the main bracket.

3. The vehicle seat according to claim 1,
wherein diameters of the at least three first holes are larger than diameters of the at least three second holes.
